(19) United States
(12) Patent Application Publication
(10) Pub. No.: US 2014/0266694 A1
(43) Pub. Date: Sep. 18, 2014

(54) Body Temperature Warning System

(71) Applicant: SAMUEL GREYSON MCCLUSKEY, Indian Trail, NC (US)

(72) Inventors: Samuel Greyson McCluskey, Indian Trail, NC (US); Alexander N. Bertha, New York, NY (US); Martin C. Williams, Brooklyn, NY (US); Alyssa R. Mayo, New York, NY (US); Adam C. Wendel, New York, NY (US)

(73) Assignee: Samuel Greyson McCluskey, Indian Trail, NC (US)

(21) Appl. No.: 13/832,572

(22) Filed: Mar. 15, 2013

(51) Int. Cl. G08B 21/02

(52) U.S. Cl. CPC G08B 21/02
USPC 340/539.12

(57) ABSTRACT

Methods and systems for avoiding undesired body temperatures in children, the elderly/infirm, and/or animals by transmitting one or more warning messages to one or more predetermined recipients so that corrective action can be taken. Using a child as an example, a wearable monitoring device is used to sense the presence of the child and to sense the body temperature of the child. When the monitoring device detects that it is being worn and that the sensed body temperature satisfies a threshold, the monitoring device transmits a warning message.

### BACKGROUND

The present invention relates to methods and systems for avoiding undesired body temperatures in children, the infirm, and/or non-human animals by transmitting one or more warning messages to one or more predetermined recipients so that corrective action can be taken.

When an animal's body heat overwhelms the animal's thermoregulatory mechanism, there is increased risk of developing hyperthermia. If the animal is a middle-age human, the animal can easily take steps to counter any increase in body heat. In contrast, children, infirm adults, and pets (e.g., dogs) may be in situations, such as being unintentionally left in a parked car, where they are exposed to high temperature environments, with little available means to change the environment. Indeed, National statistics show that out of all heat stroke incidents involving children, the majority of casualties were due to vehicular hyperthermia. A similar situation relates to hypothermia.

Numerous proposals have been made to address such situations. For example, U.S. Pat. No. 8,212,665 discloses a system where a baby car seat is fitted with a pressure sensor to detect the presence of a child, and an alarm is sounded in situations indicating that the child may have been left in the car unintentionally. Related U.S. Patent Application Publication 2012/0232749 discloses a system where an increased ambient temperature is used to trigger an alarm, such as an alert sent to a parent's cellphone, when the system detects that the child may have been left in the car unintentionally. The parent is then able to take appropriate steps to alleviate the situation.

While the prior art approaches may be suitable for some situations, they are not suitable for all situations and are typically unduly complex. As such, there remains a need for alternative approaches to inhibiting over/under-heating of children and the like.

### SUMMARY

Described below are methods and systems for avoiding undesired body temperatures in children, the elderly/infirm, and/or animals by transmitting one or more warning messages to one or more predetermined recipients so that corrective action can be taken. Using a child as an example, a wearable monitoring device is used to sense the presence of the child and to sense the body temperature of the child. When the monitoring device detects that it is being worn and that the sensed body temperature satisfies a threshold (e.g., is above a first limit), the monitoring device transmits a warning message.

In one or more embodiments, a method of warning about undesired body temperatures is provided. The method includes determining that a monitoring device is being worn by an animal based on a presence sensor of the monitoring device. The method further includes monitoring the body temperature of the animal by via a thermal sensor of the monitoring device while the monitoring device is being worn by the animal. The method also includes transmitting a first warning message to a remote device in response to both the following conditions being simultaneously satisfied: 1) the presence sensor indicating that the device is being worn by the animal; 2) the thermal sensor indicating that the body temperature of the animal satisfies a first temperature threshold. As mentioned, the animal may be a human, such as a child or elderly person, or may be a non-human animal such as a dog. The first warning message may include an indication of the body temperature sensed by the thermal sensor. The predetermined remote device that is the recipient of the warning message may display the body temperature as indicated in the first warning message. The threshold may be a high temperature threshold, and satisfying the threshold may mean being at a temperature at or above the threshold. The threshold may be a low temperature threshold, and satisfying the threshold may mean being at a temperature at or below the threshold.

In one or more embodiments, a body temperature warning system includes a wearable device. The wearable device includes a presence sensor, a thermal sensor, a wireless transmitter, and a controller. The presence sensor is configured to detect when the wearable device is being worn by an animal. The thermal sensor is configured to measure a body temperature of the animal when the animal is wearing the wearable device. The controller is operatively connected to the presence sensor, the thermal sensor, and the transmitter; and configured to cause the transmitter to transmit a first warning message in response to both the following conditions being simultaneously satisfied: 1) the presence sensor indicates that the device is being worn by the animal; 2) the thermal sensor indicates that the body temperature of the animal meets or exceeds a first temperature threshold. The first warning message may include an indication of the body temperature sensed by the thermal sensor. The system may further include a first wireless communications device associated with a caregiver; with the controller being configured to cause the transmitter to transmit the first warning message toward the first wireless communications device in response to the conditions being simultaneously met.

The various aspects discussed above may be used alone or in any combination. Further, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 shows a body temperature warning system according to one or more embodiments.

FIG. 2 shows a monitoring device according to one or more embodiments being worn by a child in a car seat in a vehicle.

FIG. 3 shows a perspective view of the monitoring device of FIG. 2.

FIG. 4 shows a simplified schematic of the monitoring device of FIG. 2.

FIG. 5 shows a flowchart of logic employed by the monitoring device of FIG. 2.

FIG. 6 shows the monitoring device may be worn by various animals.

### DETAILED DESCRIPTION

The present application is directed to methods and systems for avoiding undesired body temperatures in children, the elderly/infirm, and/or animals by transmitting one or more warning messages to one or more predetermined recipients so that corrective action can be taken. In the discussion below, one or more illustrative embodiments are discussed initially in the context of child 10 left in a car seat 22 in an unattended vehicle 20. However, it should be understood that the method(s) and system(s) described herein can be used in other situations, as discussed further below.

One illustrative embodiment of a body temperature warning system is shown in FIG. 1, and generally indicated at 5. The system 5 includes a monitoring device 40, and advantageously includes at least one of a cellphone 7 and a mobile warning device 8. The system 5 may further include a relay device 9, discussed further below. The various portions of the system 5 may communicate via a suitable communications network, such as cellular network 8.

Referring to FIG. 2, a child 10 is shown secured in a child safety seat (“car seat”) 22 by a suitable harness 24, with the car seat 22 disposed in vehicle 20. The child 10 is wearing a monitoring device 40 about his neck and resting on his shoulders, as discussed further below. For this illustrative embodiment, the child's mother 12 is the driver of the vehicle 20, and mother 12 has an associated cellphone 7 which communicates with cellular network 6 in a conventional fashion.

The monitoring device 40 is shown in greater detail in FIGS. 3-4. The monitoring device 40 includes a housing 42 that houses a presence sensor 50, a body heat thermal sensor 52, a transmitter 56, a controller 54, a battery 58, and a user interface 60. The housing 42 advantageously has an overall arc shape, similar to a horseshoe, with a peripheral opening 46. The housing 42 may advantageously have a generally triangular cross-section, with a wider bottom 44 than top 43, and a sloped inner wall 48. The housing 42 may advantageously be formed of a cushion material, with a suitable fabric covering, as is desired.

The monitoring device 40 is shown in greater detail in FIGS. 2-3. The monitoring device 40 includes a housing 42 that houses a presence sensor 50, a body heat thermal sensor 52, a transmitter 56, a controller 54, a battery 58, and a user interface 60. The housing 42 advantageously has an overall arc shape, similar to a horseshoe, with a peripheral opening 46. The housing 42 may advantageously have a generally triangular cross-section, with a wider bottom 44 than top 43, and a sloped inner wall 48. The housing 42 may advantageously be formed of a cushion material, with a suitable fabric covering, as is desired.

As mentioned above, the housing 42 houses the presence sensor 50, body heat thermal sensor 52, transmitter 56, controller 54, battery 58, and user interface 60. The presence sensor 50 is configured to determine when the monitoring device 40 is being worn by child 10. The presence sensor 50 may be of the capacitance-type that supplies a signal indicating the child 10 is presently wearing the monitoring device 40 when there is a change in the near-field capacitance that indicates that the monitoring device 40 is in contact with the child 10. In some embodiments, the presence sensor 50 may take other forms such as a pulse/heart rate sensor that indicates presence when a pulse/heart rate are detected. The thermal sensor 52 is configured to measure the body heat of the child 10, preferably by direct contact with the skin of the child 10. The transmitter 56 is configured to transmit information via radio waves. The transmitter 56 advantageously takes the form of a suitable cellular transceiver for communicating with the cellular network 6 via radio waves in a conventional fashion, such as by using GSM, wCDMA, LTE, or other known protocols. The controller 54 is operatively connected to the presence sensor 50, thermal sensor 52, transmitter 56, battery 58, and user interface 60, and controls their operation, optionally under input received via the user interface 60. The controller 54 may take any suitable form, such as microprocessor, ASIC, dedicated discrete circuitry, or the like. The battery 58 supplies power to the controller 54 and the rest of the electronics, such as the presence sensor 50 and the thermal sensor 52. The user interface 60, which is optional, may include one or more of: suitable control/input buttons 62, a display 64, a speaker or other audio output device 66, and indicator lights 68. The control/input buttons 62 may be used to vary the settings used by the controller 54, such as threshold temperatures, as discussed further below. The display 64 may be used in conjunction with the control/input buttons 62, and may further function to display relevant information, such as the currently sensed body temperature and current battery status. The speaker 66 may be used to generate operator feedback, and to sound audible alarm(s), as discussed further below. The indicator lights 68 may be used for both input and/or control command feedback and for indicating the status of the monitoring device 40.

As indicated above, the body temperature warning system 5 includes the monitoring device 40, and may advantageously include a remote device, such as the mother's cellphone 7, a personal digital assistant, a personal computer, and/or a mobile warning device 8. The mobile warning device 8 may be an enhanced key fob or the like, which includes a receiver for receiving warning message(s) originating from the monitoring device 40, and suitable alert means, such as an audible alarm and/or visual alarm. The mobile warning device 8 may include a mounting clip to facilitate carrying thereof by the corresponding caregiver. In some embodiments, the overheating warning system may also include a wireless communications relay device 9, such as a bidirectional device 9 that receives a Wi-Fi signal from the monitoring device 40 and transmits a corresponding cellular network signal.

The overheating warning system works to notify one or more predetermined, and presumably responsible, people when the body temperature of the child 10 satisfies a warning threshold, such as threshold T₁. In particular, the monitoring device 40 transmits a warning message to one or more predetermined recipients when the monitoring device 40 determines that the monitoring device 40 is both being worn by the child 10 and the child's body temperature satisfies the threshold. It should be understood that the warning threshold may be a high temperature threshold, in which case satisfying the threshold means that the sensed body temperature is above, or at or above, the threshold. Alternatively, the warning threshold may be low temperature threshold, in which case satisfying the threshold means that the sensed body temperature is below, or at or below, the threshold.

The monitoring device 40 may follow the logic presented in the flowchart of FIG. 4. In step 110, the controller 54 determines, based on indications from the presence sensor 50, whether the monitoring device 40 is being worn by the child 10. If not, the controller 54 may wait a period of time (step 120), such as one second, and then check again. If the child's presence is detected, then the controller 54 determines, based on the most recent indications from the thermal sensor 52, whether the child's body temperature satisfies the warning threshold T₁ (step 130). If the threshold T₁ is not satisfied, the controller 54 may wait a period of time (step 120), and then return to step 110. If the temperature satisfies the warning threshold T₁—meaning that the body temperature is unacceptable—the controller 54 then causes the transmitter 56 to transmit a warning message to the one or more predetermined recipients (step 150). The monitoring device 40 may send the warning message once and terminate the process, but advantageously returns to waiting step 120, resulting in additional warning messages being sent until the sensed body temperature no longer satisfies the threshold T₁ or the monitoring device 40 is removed from the child 10.

The warning message may simply indicate to the recipient that there is a problem with the child's body temperature, optionally with an reminder that the child 10 is in the vehicle 20. The warning message may optionally include a location of the child 10, such as derived from a GPS unit (not shown) in the monitoring device 40, or derived from the vehicles GPS unit (which is optionally in communication with the controller 54 via transmitter 56 or different suitable transceiver), or derived from information from the cellular network 6. The warning message may optionally include an indication of the sensed body temperature. The warning message may also include an indication of, or instructions for, the alerting actions to be taken by the receiving device.

In some embodiments, a graduated warning approach may be taken. Thus, there may be a first threshold T₁ and a second threshold T₂, with the second threshold T₂ being farther from the desired temperature than the first threshold T₁. For example, for a normal desired temperature of 98.6°, the first threshold T₁ may be 100°, with the second threshold T₂ being 102°. A simplified graduated warning approach is shown in dashed lines in FIG. 4. As shown, the monitoring device 40, after determining, based on the most recent indications from the thermal sensor 52, that the child's body temperature satisfies the first warning threshold T₁ (step 130), the controller 54 may determine if the child's body temperature satisfies the second threshold T₂ (step 140). If not, the process may proceed to step 150 where, as above, a warning message of a first type (type A) is transmitted. On the other hand, if the second threshold T₂ is exceeded, the process may proceed to step 160, where a warning message of a second type (type B) is transmitted. The second type of warning message may be transmitted to additional predetermined recipients and/or may cause a stronger alarm to be initiated. For example, the first type of warning message may be transmitted to the cellphone 7 of the mother 12, and cause a mild visual alarm at the cellphone 7, while the second type of warning message may be transmitted to cellphones 7 of the mother 12, the father 14, and the grandmother 16, and cause both an audio and a visual alarm at those cellphones 7. This graduated warning alarm approach can be extended to more than two thresholds, and could include notifying the local law enforcement authorities when the second threshold T₂ is satisfied, as appropriate.

The discussion above has been in the context of a monitoring device 40 that has a transmitter 56 configured to communicate with the cellular network 6 via radio waves in a conventional cellular network fashion. However, in some embodiments, the transmitter 56 may alternatively or additionally be configured to use a local area network, such a Wi-Fi network operating according to 802.11 protocol or other known wireless communications protocols, to transmit the warning message(s).

The discussion above has been in the context of monitoring the body temperature of a child 10 in a car seat 22. However, the present approach may alternatively be used to monitor the body temperature of an elderly and/or infirm person (e.g., grandmother 16), with the warning messages going to one or more children thereof, and/or other designated caregiver. Further, the present approach may be used to monitor the body temperature of an animal 18, such as the family dog or prized livestock, which will typically be a mammal.

In some embodiments, the monitoring device 40 may also trigger local visual and/or audible alarms, using display 64 and/or speaker 66, when a warning message is transmitted. However, it may be undesirable to do so in all situations, as a local audible alarm may distress the child 10. Thus, such local alarming may be optional, and may be based on a changeable configuration setting of the monitoring device 40.

In some embodiments, the monitoring device 40 may further include an ambient temperature sensor (not shown) operatively connected to the controller 54, and the warning message may optionally include an indication of the ambient temperature in addition to an indication of the relevant body temperature.

In some embodiments, the monitoring device 40 may further include a carbon monoxide sensor (not shown) operatively connected to the controller 54, and carbon monoxide alert message(s) may additionally be transmitted when an unhealthy carbon monoxide situation is detected.

In some embodiments, the transmitter 56 may be a transceiver, and monitoring device 40 may be configured to selectively receive audio signals (e.g., music) and play the same via speaker 66, or other suitable playback means.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of warning about undesired body temperatures, the method comprising:
determining that a monitoring device is being worn by an animal based on a presence sensor of the monitoring device;
monitoring the body temperature of the animal by via a thermal sensor of the monitoring device while the monitoring device is being worn by the animal;
transmitting a first warning message to a remote device in response to both the following conditions being simultaneously satisfied:
the presence sensor indicating that the device is being worn by the animal;
the thermal sensor indicating that the body temperature of the animal satisfies a first temperature threshold.

2. The method of claim 1, wherein the animal is a human.

3. The method of claim 1, wherein the first warning message includes an indication of the body temperature sensed by the thermal sensor.

4. The method of claim 3, further comprising the remote device displaying the body temperature as indicated in the first warning message

5. The method of claim 1, wherein the presence sensor of the monitoring device is a capacitive-type sensor.

6. The method of claim 1, wherein the transmitting comprises transmitting the first warning message to a predetermined wireless communications device associated with a caregiver associated with the animal.

7. The method of claim 1, further comprising:
transmitting a second warning message to the remote device in response to both the following conditions being simultaneously satisfied:
the presence sensor indicating that the device is being worn by the animal;
the thermal sensor indicating that the body temperature of the animal satisfies a second temperature threshold, the second threshold being farther from a normal temperature of the animal than the first threshold.

8. The method of claim 1, wherein the transmitting comprises transmitting the first warning message using a cellular communications network protocol.

9. The method of claim 1 wherein the monitoring device comprises a generally U-shaped body housing the presence sensor, the thermal sensor, and a transmitter.

10. The method of claim 1 wherein the threshold is a high temperature threshold, and satisfying the threshold comprises being at a temperature at or above the threshold.

11. The method of claim 1 wherein the threshold is a low temperature threshold, and satisfying the threshold comprises being at a temperature at or below the threshold.

12. An body temperature warning system, comprising:
a wearable device comprising:
a presence sensor configured to detect when the wearable device is being worn by an animal;
a thermal sensor configured to measure a body temperature of the animal when the animal is wearing the wearable device;
a wireless communications transmitter;
a controller operatively connected to the presence sensor, the thermal sensor, and the transmitter; and configured to cause the transmitter to transmit a first warning message in response to both the following conditions being simultaneously satisfied:
the presence sensor indicates that the device is being worn by the animal;
the thermal sensor indicates that the body temperature of the animal meets or exceeds a first temperature threshold.

13. The warning system of claim 12, wherein the first warning message includes an indication of the body temperature sensed by the thermal sensor.

14. The warning system of claim 12, wherein the presence sensor is a capacitance sensor.

15. The warning system of claim 12, wherein the controller is configured to cause the transmitter to transmit a second warning message in response to both the following conditions being met:
the presence sensor indicates that the device is being worn by the animal;
the thermal sensor indicates that the body temperature of the animal meets or exceeds a second temperature threshold, the second threshold being higher than the first threshold.

16. The warning system of claim 12, wherein the transmitter is configured to communicate with a cellular network using a cellular communications protocol.

17. The warning system of claim 12:
further comprising a first wireless communications device associated with a caregiver;
wherein the controller is configured to cause the transmitter to transmit the first warning message toward the first wireless communications device in response to the conditions being simultaneously met.
